(19) United States
(12) Patent Application Publication
(10) Pub. No.: US 2014/0214769 A1
(43) Pub. Date: Jul. 31, 2014

(54) BACKUP STORAGE SYSTEM, BACKUP STORAGE APPARATUS, AND METHOD FOR BACKING UP DATA

(71) Applicants: TOSHIBA SOLUTIONS CORPORATION, Tokyo (JP); KABUSHIKI KAISHA TOSHIBA, Tokyo (JP)

(72) Inventor: Masaaki TAKAYAMA, Fuchu-shi (JP)

(21) Appl. No.: 13/955,541

(22) Filed: Jul. 31, 2013

Related U.S. Application Data
(63) Continuation of application No. PCT/JP2013/051641, filed on Jan. 25, 2013.

(51) Int. Cl. G06F 17/30

(52) U.S. Cl. CPC G06F 17/30312
USPC 707/645

(57) ABSTRACT

According to one embodiment, a data storage device generates a full backup image or an incremental backup image as a backup image depending on whether the backup is of a first generation. The generated backup image is transferred to a backup storage device. A full backup generation unit of the backup storage device executes a merge process of merging an incremental backup image with a full backup image in order of generation. A reverse incremental backup acquisition unit of the backup storage device acquires, in order of generation, a reverse incremental backup image used to restore the full backup image not subjected the merge process from the full backup image subjected to the merge process.

### CROSS REFERENCE TO RELATED APPLICATIONS

This application is a Continuation Application of PCT Application No. PCT/JP2013/051641, filed Jan. 25, 2013, the entire contents of which are incorporated herein by reference.

### FIELD

Embodiments described herein relate generally to a backup storage system, a backup storage apparatus, and a method for backing up data.

### BACKGROUND

In recent years, increased capacities of storage devices used by host computers (hereinafter referred to as data storage devices) have been promoted. Thus, there has been a demand for efficient backup of data in the data storage device.

Furthermore, a backup storage system has been developed which uses a storage device different from the data storage device (this storage device is hereinafter referred to as a backup storage device), as a destination to which data in the data storage device is backed up. A known typical backup method applied to such a backup storage system is an incremental backup method. The incremental backup method uses the following procedure.

During the first (zero-generation) backup, the data storage device generates a backup image that is a backup of data in the entire backup target area (that is, a full backup image). The zero-generation full backup image is transferred from the data storage device to the backup storage device and stored in the backup storage device. The zero-generation full backup image is represented as #0.

During the second and subsequent backups, the data storage device generates logical incremental information. The logical incremental information is referred to as an incremental backup (incremental backup image) and represents an increment resulting from a change made to the data in the backup target area since the preceding backup (that is, the increment corresponds to the change). The incremental backup data is transferred from the data storage device to the backup storage device and stored in the backup storage device. Incremental backup images acquired during the second backup, the third backup, . . . are represented as #1-#0, #2-#1, . . . .

Thus, during the second and subsequent backups, the incremental backup method transfers the increment (more specifically, the incremental backup image) from the data storage device to the backup storage device. This enables a reduction in the amount of data transferred and in the storage capacity of the backup storage device.

The incremental backup method uses the backup images (#0, #1-#0, #2-#1, . . . ) in the backup storage device to restore the data in the data storage device. For example, the second-generation data (hereinafter referred to as data #2) is restored by the following procedure.

(1) The data storage device restores the data #0 in the data storage device based on the full backup image #0 in the incremental backup storage device.

(2) The data storage device merges the incremental backup image #1-#0 in the incremental backup storage device with the data #0 and thus restores the data #1 in the data storage device.

(3) The data storage device merges the incremental backup image #2-#1 in the incremental backup storage device with the data #1 and thus restores the data #2 in the data storage device.

In general, data to be restored in the data storage device is the latest-generation data. However, the above-described conventional technique takes time to restore the latest-generation data. This is because, after the first-generation data is restored from the first-generation full backup image, all incremental backup images up to the latest-generation data need to be merged with the first-generation data. Thus, the conventional technique requires a longer time for the restoration of data in accordance with the progress in generation.

### BRIEF DESCRIPTION OF THE DRAWINGS

FIG. 1 is a block diagram showing an exemplary hardware configuration of a computer system according to an embodiment;

FIG. 2 is a block diagram mainly showing an exemplary functional configuration of a backup storage system shown in FIG. 1;

FIG. 3 is a block diagram showing an exemplary configuration of a backup processing unit in a data storage device in FIG. 2;

FIG. 4 is a block diagram showing an exemplary configuration of a backup processing unit in a backup storage device shown in FIG. 2;

FIG. 5 is a diagram showing an exemplary configuration of the area in a logical disk in the data storage device shown in FIG. 2 and the area in a logical disk in the backup storage device shown in FIG. 2;

FIG. 6A is a diagram showing an example of a backup mechanism applied in the embodiment;

FIG. 6B is a diagram showing an example of a backup mechanism applied in the conventional technique;

FIG. 7 is a flowchart showing an exemplary procedure for a first backup generation process according to the embodiment;

FIG. 8 is a flowchart showing an exemplary procedure for a second backup generation process according to the embodiment;

FIG. 9 is a diagram illustrating generation of a reverse incremental backup image and a full backup image according to the embodiment;

FIG. 10 is a flowchart showing an exemplary procedure for a data restoration process according to the embodiment; and

FIG. 11 is a diagram showing an example of an incremental backup image applied in a variation of the embodiment.

### DETAILED DESCRIPTION

In general, according to one embodiment, a backup storage system comprises a data storage apparatus configured to store data accessed by a host computer and a backup storage apparatus configured to store a backup image of the data stored in the data storage apparatus. The data storage apparatus comprises a backup generation unit and a backup image transfer unit. The backup generation unit is configured to generate a first-generation full backup image during a first backup as the backup image. The backup generation unit is further configured to generate an incremental backup image during each backup succeeding the first backup as the backup image. The incremental backup image represents an increment resulting from a data change made since a preceding-generation backup. The backup image transfer unit is configured to transfer the first-generation full backup image to a first storage area in the backup storage apparatus when the first-generation full backup image is generated. The backup image transfer unit is further configured to transfer the incremental backup image to a second storage area in the backup storage apparatus when the incremental backup image is generated. The backup storage apparatus comprises a full backup generation unit and a reverse incremental backup acquisition unit. The full backup generation unit is configured to repeat a merge process for updating a first full backup image to a succeeding-generation full backup image by merging an incremental backup image of a generation succeeding the first full backup image with the first full backup image, with the first full backup image stored in the first storage area and with at least the succeeding-generation incremental backup image stored in the second storage area. The reverse incremental backup acquisition unit is configured to repeat, in order of generation, an operation for acquiring and storing a reverse incremental backup image of a generation identical to a generation of the full backup image not subjected to the merge process, in a third area in the backup storage apparatus based on the incremental backup image transferred to the second storage area. The reverse incremental backup image represents a part of the full backup image not subjected to the merge process. The reverse incremental backup image is used to restore the full backup image not subjected to the merge process from the full backup image subjected to the merge process. The part of the full backup image not subjected to the merge process corresponds to the succeeding-generation incremental backup image.

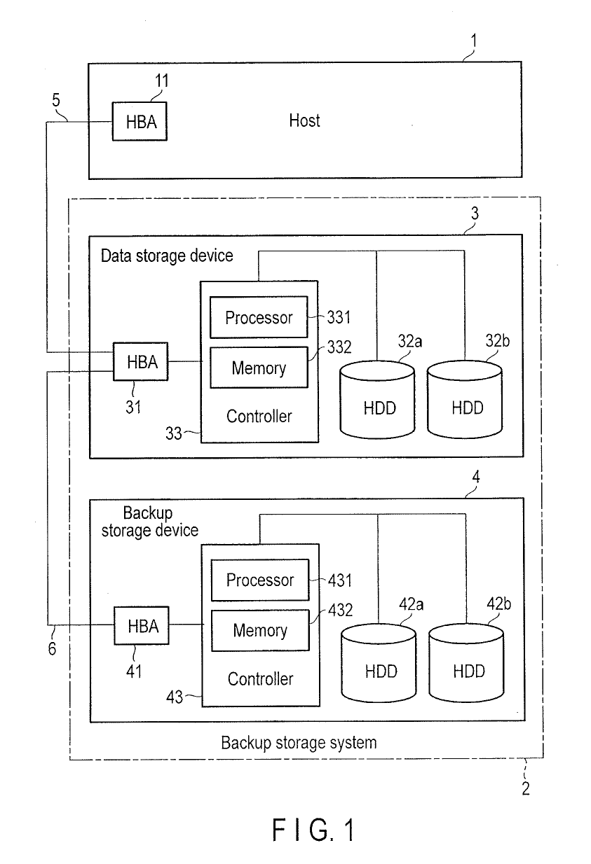

FIG. 1 is a block diagram showing an exemplary hardware configuration of a computer system according to an embodiment. The computer system includes a host computer (hereinafter referred to as a host) 1 and a backup storage system 2. The backup storage system 2 includes a data storage device 3 and a backup storage device 4.

The host 1, the data storage device 3, and the backup storage device 4 include host bus adapters (HBA) 11, 31, and 41, respectively. The HBAs 11 and 31 interconnect the host 1 and the data storage device 3 by, for example, a fibre channel (FC) 5 serving as a host interface bus. The host 1 is a physical computer such as a server or a client personal computer (client PC). In the host 1, an application for accessing data in the data storage device 3 operates. In accordance with the application, the host 1 utilizes the data storage device 3 via the FC 5. Instead of the FC 5, another host interface bus may be used such as Ethernet (registered trade mark), Small Computer System Interface (SSCI), Internet SCSI (iSCSI), Serial Attached SCSI (SAS), or Serial AT Attachment (SATA).

The HBAs 31 and 41 interconnect the data storage device 3 and the backup storage device 4 by, for example, an FC 6 serving as a host interface bus. The data storage device 3 stores data used by a user via the host 1. The data storage device 3 backs up data in the data storage device 3 to the backup storage device 4 via the FC 6. That is, the backup storage device 4 stores a backup image of the data in the data storage device 3. The backup image will be described later. Instead of the FC 6, another host interface bus as described above may be used.

The data storage device 3 includes, in addition to the HBA 31, one or more hard disk drives (HDDs), for example, HDDs 32a and 32b. The HDDs 32a and 32b store data accessed by the host 1 (that is, data used by the user). The data storage device 3 further includes a controller 33. The controller 33 is connected to the HBA 31. The controller 33 is also connected to the HDDs 32a and 32b via a disk interface bus such as Ethernet, SCSI, iSCSI, SAS, or SATA. In the embodiment, the HDDs 32a and 32b are SATA-HDDs, and the controller 33 is connected to the HDDs 32a and 32b via SATA. At least one of the HDDs 32a and 32b may be a storage drive other than an HDD, for example, a solid state drive (SSD).

The controller 33 controls accesses to the HDDs 32a and 32b (that is, data inputs and outputs), backup of data, and the like. In the controller 33, first control software (firmware) for the above-described control operates. The controller 33 includes a processor 331 and a memory 332 in order to implement the operation of the first control software. The memory 332 includes a nonvolatile memory such as a ROM or a flash ROM and a volatile memory such as a RAM. The nonvolatile memory stores the first control software. A part of a storage area in the volatile memory is used as a work area for the processor 331.

The term “backup” generally means an operation of acquiring a backup (that is, a backup operation) and data acquired by the backup operation (that is, backed-up data). Thus, for distinction, the description below uses “backup” as a term representing a backup operation and “backup image” as a term representing data acquired by the backup operation.

The backup storage device 4 includes, in addition to the HBA 41, one or more HDDs, for example, HDDs 42a and 42b. The HDDs 42a and 42b store a backup image of the data in the data storage device 3. The backup storage device 4 further includes a controller 43. The controller 43 is connected to the HBA 41. The controller 43 is also connected to the HDDs 42a and 42b via such a disk interface bus as described above. In the embodiment, the HDDs 42a and 42b are assumed to be SATA-HDDs similarly to the HDDs 32a and 32b, and the controller 43 is assumed to be connected to the HDDs 42a and 42b via SATA. One of the HDDs 42a and 42b may be a storage drive other than an HDD, for example, an SSD.

The controller 43 controls accesses to the HDDs 42a and 42b (that is, data inputs and outputs) and generation of a backup image, and the like. In the controller 43, second control software for the above-described control operates. The controller 43 includes a processor 431 and a memory 432 in order to implement the operation of the second control software.

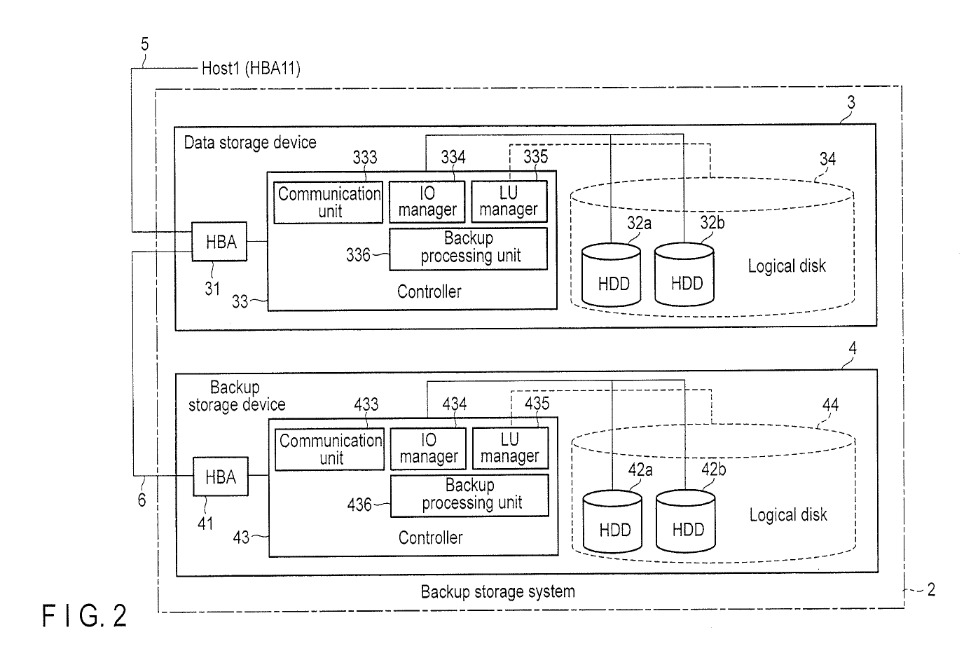

FIG. 2 is a block diagram mainly showing an exemplary functional configuration of the backup storage system 2 shown in FIG. 1. The controller 33 includes functional elements including a communication unit 333, an input/output (IO) manager 334, a logical unit (LU) manager 335, and a backup processing unit 336. On the other hand, the controller 43 includes functional elements including a communication unit 433, an IO manager 434, an LU manager 435, and a backup processing unit 436.

The communication unit 333 communicates with the communication unit 433 of the backup storage device 4 via the FC 6. The IO manager 334 manages data input to and data output from the HDDs 32a and 32b. The LU manager 335 virtualizes storage areas in the HDDs 32a and 32b and thus constructs (defines) a logical disk (logical unit) 34 recognized by the host 1. Input to and output from the other hardware units including the host 1 are executed on the logical disk 34.

The backup processing unit 336 executes processes for backup of the data in the data storage device 3 and restoration based on the backed-up data. The process for data backup executed by the backup processing unit 336 includes generation of a backup image as backup data. Backup images generated by the backup processing unit 336 are classified into full backup images and incremental backup images.

The full backup image is backup data generated by the first (zero-generation) backup. That is, the backup processing unit 336 generates a full backup image during the first backup. The full backup image generated during the first backup is represented as a full backup image #0 (more specifically, a zero-generation full backup image). The full backup image #0 includes the backup target data for the first backup itself.

On the other hand, incremental backup images are backup data generated during backups except for the first backup. That is, the backup processing unit 336 generates incremental backup images during the backups, except for the first backup. An incremental backup image generated during the ith (i=1, 2, . . . ) backup is represented as an incremental backup image #i-#i−1 (more specifically, the ith-generation incremental backup image #i-#i−1).

The incremental backup image #i-#i−1 includes an increment (that is, a changed portion) in backup target data resulting from a data change made during a period from the last ([i−1]th-generation) backup until the current (ith-generation) backup. The data change includes not only writing new data to an address to which data has already been written (that is, data update) but also writing new data to an address to which no data has been written (or invalid data has been written).

The generated backup image (that is, the full backup image #0 or the incremental backup image #i-#i−1) is transferred to the backup storage device 4 by the communication unit 333. The full backup image #0 or incremental backup image #i-#i−1 transferred to the backup storage device 4 is stored in a logical disk 44 described later.

The communication unit 433 communicates with the communication unit 333 of the data storage device 3 via the FC 6. The IO manager 434 manages data input to and data output from the HDDs 42a and 42b. The LU manager 435 virtualizes storage areas in the HDDs 42a and 42b and thus constructs (defines) a logical disk (logical unit) 44 recognized by the host 1. Inputs to and outputs from the other hardware units including the data storage device 3 are executed on the logical disk 44.

The backup processing unit 436 executes processes for backup data in the backup storage device 4. The process for the backup data executed by the backup processing unit 436 includes generation of a reverse incremental backup image #j−1-#j and update from a full backup image #j−1 to a full backup image #j. In this case, when m denotes an integer of 1 or greater, j is an integer satisfying 1≦j≦m. Reference character m denotes the number of incremental backup images #i-#i−1 (i=1, . . . , m) transferred from the data storage device 3 to the backup storage device 4 during a period from the first (zero-generation) backup until the reverse incremental backup image #j−1-#j is generated.

If m is 1, one incremental backup image #i-#i−1 (i=1), that is, an incremental backup image #1-#0, has already been transferred to the backup storage device 4. Furthermore, if m is 2 or greater, m incremental backup images #i-#i−1 (i=1, . . . m), that is, incremental backup images #1-#0 to #m-#m−1, have already been transferred to the backup storage device 4.

The reverse incremental backup image #j−1-#j corresponds to an increment in backup target data resulting from a data change made during a period from the j−1th ([j−1]th-generation) backup until the jth (jth-generation) backup. The reverse incremental backup image #j−1-#j includes the original data present before the data change. The reverse incremental backup image #j−1-#j is the [j−1]th-generation reverse increment based on the jth generation. In the description below, the reverse incremental backup image #j−1-#j is hereinafter also referred to as the [j−1]th-generation reverse incremental backup image #j−1-#j.

The backup processing unit 436 generates a reverse incremental backup image #j−1-#j based on the full backup image #j−1 (that is, the [j−1]th-generation full backup image #j−1) and an incremental backup image #j-#j−1. The reverse incremental backup image #j−1-#j is stored in the logical disk 44.

The full backup image #j−1 is the latest full backup image during the generation of the reverse incremental backup image #j−1-#j and is stored in the logical disk 44. The incremental backup image #j-#j—1 is the only incremental backup image #1-#0 transferred to the backup storage device 4 since the first (zero-generation) backup if m is 1. Furthermore, if m is 2 or greater, the incremental backup image #j-#j−1 is the jth one of m incremental backup images #1-#0 to #m-#m−1 transferred to the backup storage device 4 since the first (zero-generation) backup. The incremental backup images #1-#0 to #m-#m−1 are stored in the logical disk 44 in the backup storage device 4 in the order of transfer (generation).

The backup processing unit 436 further updates the latest full backup image #j−1 (first full backup image) based on the latest full backup image #j−1 and the incremental backup image #j-#j−1. The updated full backup image #j−1 (that is, the updated full backup image #j−1 in the logical disk 44) is newly managed as the latest-generation (that is, the jth-generation) full backup image #j. More specifically, the backup processing unit 436 merges the succeeding-generation (jth-generation) incremental backup image #j-#j−1 with the [j−1]th-generation full backup image #j−1 and thus updates the generation of the merged full backup image #j−1 to the jth generation, thus generating a jth-generation full backup image #j (second full backup image). Thus, the latest full backup image (first full backup image) is changed from the [j−1]th-generation full backup image #j−1 to the jth-generation full backup image #j.

As described above, the incremental backup images #1-#0 to #m-#m−1 are used to generate a reverse incremental backup image in the order of transfer (generation). In this case, j is an integer n of 2 or greater (j=n), and m is an integer of 2 or greater. In this case, if n is 2, when a reverse incremental backup image #n−1-#n (that is, a reverse incremental backup image #1-#2) is generated, a reverse incremental backup image #0-#1 has already been generated based on the full backup image #0 and the incremental backup image #1-#0 and stored in the logical disk 44. Furthermore, if n is 3 or greater, reverse incremental backup images #0-#1 to #n−2-#n−1 have already been generated based on the full backup image #0 to #n−2 and the incremental backup image #1-#0 to #n−1-#n−2 and stored in the logical disk 44.

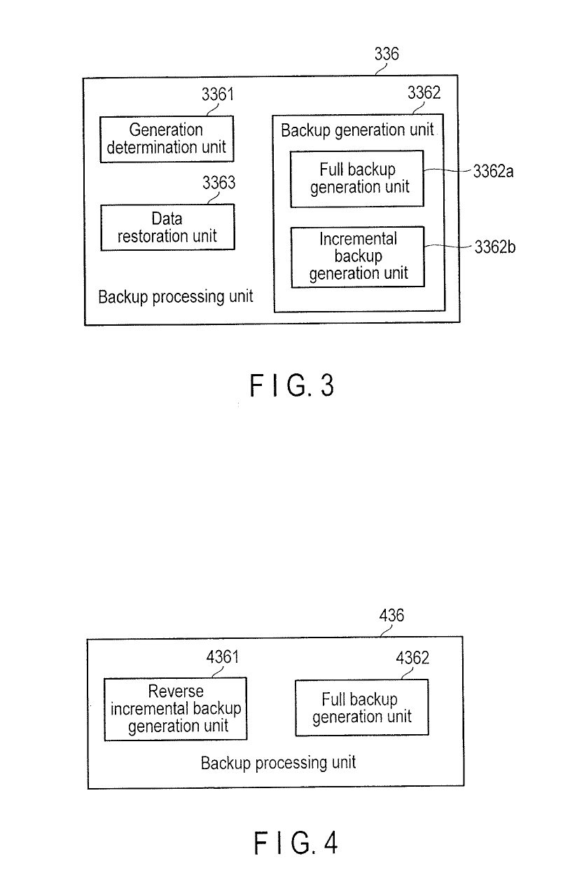

FIG. 3 is a block diagram showing an exemplary configuration of the backup processing unit 336 in the data storage device 3 shown in FIG. 2. The backup processing unit 336 includes a generation determination unit 3361, a backup generation unit 3362, and a data restoration unit 3363.

The generation determination unit 3361 determines whether the backup is of the first generation (zero-generation) during generation of a backup image. The generation determination unit 3361 determines whether the restored data is of the target generation or is newer or older than the target generation. The target generation is the generation of data to be restored in accordance with a request from the host 1.

The backup generation unit 3362 includes a full backup generation unit 3362a and an incremental backup generation unit 3362b. During the first backup, the full backup generation unit 3362a generates a full backup image #0 based on the backup target data. During the ith (i=1, 2, . . . ) backup, the incremental backup generation unit 3362b generates an incremental backup image #1-#i−1.

If, with the full backup image #n stored in the logical disk 44 of the backup storage device 4, the host 1 requests data restoration, the data restoration unit 3363 restores, based on the full backup image #n, the nth-generation data in a data restoration area 343 described later. The generation (nth generation) of the restored data is assumed to be newer than the target generation. In this case, if the target generation is the hth generation and h denotes an integer satisfying 0≦h<n≦m and h≠n−1, the data restoration unit 3363 restores the hth-generation data based on the nth-generation data (full backup image #n) and the reverse incremental backup images #n−1-#n to #h-#h+1. Similarly, if the target generation is the hth generation and h denotes an integer satisfying 0≦h<n≦m and h=n−1, the data restoration unit 3363 restores the hth-generation (that is, the [n−1]th-generation) data based on the nth-generation data (full backup image #n) and the reverse incremental backup image #n−1-#n.

Now, the generation (nth generation) of the restored data is assumed to be older than the target generation. In this case, if the target generation is the hth generation and h denotes an integer satisfying 0≦n<h≦m and h≠n+1, the data restoration unit 3363 restores the hth-generation data based on the nth-generation data and the incremental backup images #n+1-#n to #h-#h−1. Similarly, if the target generation is the hth generation and h denotes an integer satisfying 0≦n<h≦m and h=n+1, the data restoration unit 3363 restores the hth-generation (that is, the [n+1]th-generation) data based on the nth-generation data (full backup image #n) and the incremental backup image #n+1-#n.

FIG. 4 is a block diagram showing an exemplary configuration of the backup processing unit 436 in the backup storage device 4 shown in FIG. 2. The backup processing unit 436 includes a reverse incremental backup generation unit 4361 and a full backup generation unit 4362. The reverse incremental backup generation unit 4361 (reverse incremental backup acquisition unit) generates (acquires) a reverse incremental backup image #j−1-#j based on the full backup image #j−1 and the incremental backup image #j-#j−1. The full backup generation unit 4362 merges the incremental backup image #j-#j−1 with the full backup image #j−1 and thus updates the generation of the merged full backup image #j−1 to the jth generation, thus generating the jth-generation full backup image #1.

If the reverse incremental backup image #j−1-#j and the full backup image #j have been generated, the incremental backup image #j-#j−1 becomes unnecessary. Thus, the embodiment discards (for example, logically discards) the incremental backup image #j-#j−1 after the generation of the reverse incremental backup image #j−1-#j and the update of the full backup image #j−1 (that is, the generation of the full backup image #j).

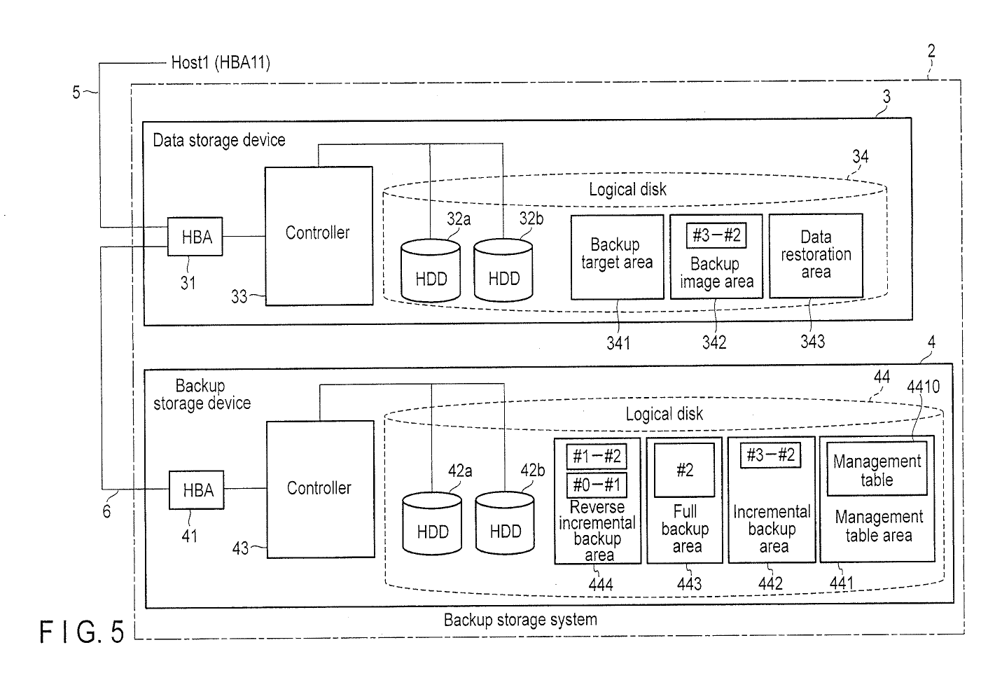

FIG. 5 shows an exemplary configuration of the area in the logical disk 34 of the data storage device 3 shown in FIG. 2 and the area in the logical disk 44 in the backup storage device 4 shown in FIG. 2. The logical disk 34 includes a backup target area 341, a backup image area 342, and a data restoration area 343. That is, a first portion of the area (logical disk area) in the logical disk 34 is used as the backup target area 341. A second portion of the logical disk area is used as the backup image area 342. A third portion of the logical disk area is used as the data restoration area 343.

The backup target area 341 is accessed by the host 1 in accordance with a request from a user and used to store backup target data. The backup image area 342 is used to temporarily store the latest backup image generated for transfer from the data storage device 3 to the backup storage device 4. The backup image stored in the backup image area 342 is the full backup image #0 or the incremental backup image #i-#i−1 (i=1, 2, . . . ). FIG. 5 shows that the latest backup image stored in the backup image area 342 is an incremental backup image #3-#2 (i=3). The data restoration area 343 (fourth storage area) is used for data restoration by the data restoration unit 3363.

On the other hand, the logical disk 44 includes a management table area 441, an incremental backup area 442, a full backup area 443, and a reverse incremental backup area 444. That is, a first portion of the area (logical disk area) in the logical disk 44 is used as the management table area 441. A second portion of the logical disk area is used as the incremental backup area 442. A third portion of the area (logical disk area) in the logical disk 44 is used as the full backup area 443. A fourth portion of the logical disk area is used as the reverse incremental backup area 444.

The management table area 441 is used to store a management table 4410 used to manage backup images stored in the incremental backup area 442, the full backup area 443, and the reverse incremental backup area 444. Entries in the management table 4410 are used to store management information for the backup images and each includes a type field, a generation status field, and an address field. If the backup images stored in the incremental backup area 442, the full backup area 443, or the reverse incremental backup area 444 is discarded, the management information for the backup images is deleted from the management table 4410.

The type field is indicative of the type of the backup image. That is, the type field includes whether the backup image is an incremental backup image, a full backup image, or a reverse incremental backup image.

The management table may be prepared for each of the incremental backup area 442, the full backup area 443, and the reverse incremental backup area 444 (that is, for each type of backup image). In this case, the type field is not necessarily needed.

The generation status field is basically indicative of the generation of a backup image. Furthermore, during the update of a backup image, the generation status field is also used to indicate that the generation of the backup image is being updated. The address field is indicative of the starting address of the logical disk 44 at which the backup image is stored and the size of the backup image.

The incremental backup area 442 (second storage area) is used to store incremental backup images transferred from the data storage device 3 to the backup storage device 4 during the backups except for the first backup. The embodiment discards (deletes) the incremental backup image used to generate a reverse incremental backup image and to update (generate) a full backup image, from the incremental backup area 442. Thus, if, for example, the [n−1]th-generation (1≦n≦m) full backup image #n−1 is stored in the full backup area 443, the incremental backup images of one or more (“m−n+1”) generations newer than the [n−1]th generation remain in the incremental backup area 442. FIG. 5 shows that only the incremental backup image #3-#2 (n=m=3) is stored in the incremental backup area 442.

The full backup area 443 (first storage area) is used to store the latest full backup image. FIG. 5 shows that the full backup image #2 is stored in the full backup area 443. As is apparent from the above description, when the generation of the latest full backup image is denoted by j and the generation of the latest incremental backup image stored in the incremental backup area 442 is denoted by m, j is equal to or less than m.

The reverse incremental backup area 444 (third storage area) is used to store reverse incremental backup images. FIG. 5 shows that the reverse incremental backup images #0-#1 and #1-#2 are stored in the reverse incremental backup area 444.

In the state shown in FIG. 5, the reverse incremental backup generation unit 4361 can generate a reverse incremental backup image #2-#3 based on the full backup image #2 and the incremental backup image #3-#2. Furthermore, the full backup generation unit 4362 can generate a full backup image #3 based on the full backup image #2 and the incremental backup image #3-#2.

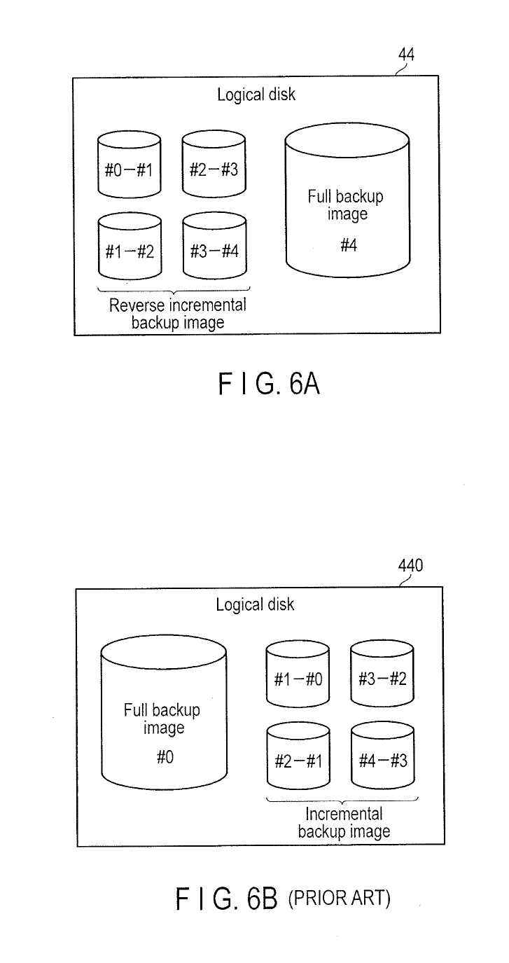

FIG. 6A shows an example of a backup mechanism applied in the embodiment. FIG. 6B shows an example of a backup mechanism applied in the conventional technique. FIG. 6A and FIG. 6B each assume that the incremental backup images #1-#0 to #4-#3 up to the fourth generation have been acquired.

In the example in FIG. 6A, a fourth-generation full backup image #4 and reverse incremental backup images #0-#1 to #3-#4 are stored in the logical disk 44. On the other hand, in the example in FIG. 6B, a zero-generation full backup image #0 and incremental backup images #1-#0 to #4-#3 are stored in a logical disk 440 corresponding to the logical disk 44.

Now, the operation of the embodiment will be described. First, generation of a backup image by the data storage device 3 will be described. According to the embodiment, the host 1 notifies the data storage device 3 of a schedule for generation of backup images in accordance with the user's instruction. The backup processing unit 336, operating on the controller 33 of the data storage device 3, generates backup images in accordance with the schedule.

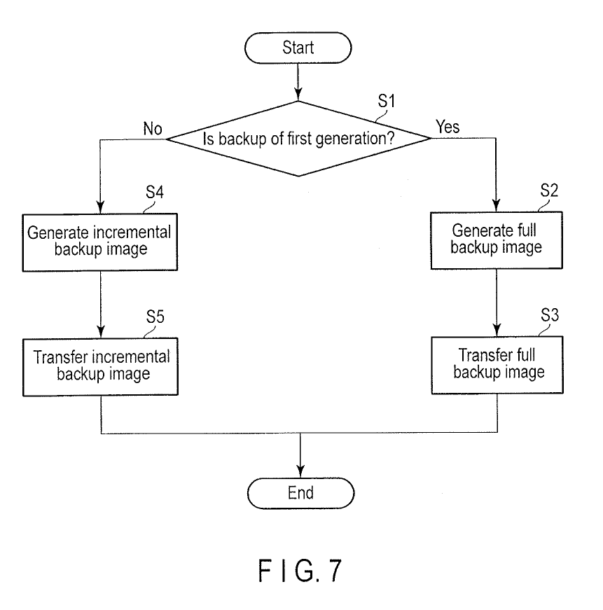

An exemplary procedure for a process for generating a backup image (a first backup generation process) according to the embodiment will be described with reference to a flowchart in FIG. 7. First, the generation determination unit 3361 of the backup processing unit 336, operating on the controller 33 in the data storage device 3, determines whether the backup is of the first generation (zero generation) at every backup timing indicated in the schedule.

If the backup is of the first generation (Yes in step S1), the generation determination unit 3361 starts the full backup generation unit 3362a. Then, the full backup generation unit 3362a generates a full backup image #0 (step S2). That is, the full backup generation unit 3362a generates a backup image of the data in the entire backup target area 341 in the logical disk 34, in the backup image area 342 as a full backup image #0. A method for generating a full backup image is well known, and a specific generation procedure is omitted.

The communication unit 333 of the data storage device 3 functions as a backup image transfer unit and thus transfers the full backup image #0 generated in the backup image area 342 to the backup storage device 4 (step S3). That is, the communication unit 333 of the data storage device 3 cooperates with the communication unit 433 of the backup storage device 4 in transferring the full backup image #0 to the full backup area 443 in the backup storage device 4. Thus, the full backup image #0 is stored in the full backup area 443.

The backup processing unit 436 of the backup storage device 4 stores management information (backup image management information) used to manage the full backup image #0 stored in the full backup area 443, in the management table 4410. Information used for the management information and indicating the type and generation of the full backup image #0 is transferred simultaneously with the transfer of the full backup image #0 from the data storage device 3 to the backup storage device 4.

In contrast, if the backup is not of the first generation (zero generation) (No in step S1), that is, if the backup is of the ith generation (i denotes an integer of 1 or greater), the generation determination unit 3361 starts the incremental backup generation unit 3362b. Then, the incremental backup generation unit 3362b generates an ith-generation incremental backup image #1-#i−1 (step S4). That is, the incremental backup image generation unit 3362b generates, in the backup image area 342, an incremental backup image #i-#i−1 representing an increment resulting from a change made to the data in the backup target area 341 since the backup of the [i−1]th-generation backup, which is the preceding generation.

The communication unit 333 of the data storage device 3 cooperates with the communication unit 433 of the backup storage device 4 in transferring the incremental backup image #i-#i−1 generated in the backup image area 342 to the incremental backup area 442 in the logical disk 44 of the backup storage device 4 (step S5). Thus, the incremental backup image #i-#i−1 is stored in the incremental backup area 442. The backup processing unit 436 of the backup storage device 4 additionally stores management information used to manage the incremental backup image #i-#i−1 stored in the incremental backup area 442, in the management table 4410.

The full backup image #0 or incremental backup image #i-#i−1 in the backup image area 342 in the logical disk 34 are assumed to be transferred to the full backup area 443 or incremental backup area 442 in the logical disk 44. In this case, according to the embodiment, the backup image in the backup image area 342 (that is, the full backup image #0 or the incremental backup image #i-#i−1) is discarded (for example, logically discarded). That is, the latest backup image is temporarily stored in the backup image area 342.

As is apparent from the above description, after the first backup is executed, the controller 33 of the data storage device 3 generates an incremental backup image in the backup image area 342 at every backup timing. This incremental backup is stored in the incremental backup area 442 in the logical disk 44 of the backup storage device 4. The backup image in the incremental backup area 442 remains stored in the incremental backup area 442 until the backup image is used to generate a reverse incremental backup image and to update (generate) a full backup image. The state of the logical disk 44 shown in FIG. 5 is such that the incremental backup images #1-#0, #2-#1, and #3-#2 have been transferred to the incremental backup area 442 in the logical disk 44 in the order of generation, while the incremental backup images #1-#0 and #2-#1 have been used to generate reverse incremental backup images #0-#1 and #1-#2 and to update full backup images #0 and #1 (to generate full backup images #1 and #2).

Now, a process will be described which involves generating a reverse incremental backup image and updating (generating) a full backup image (second backup generation process) and which is executed in the backup storage device 4. The embodiment executes the second backup generation process in the backup storage device 4 independently of the first backup generation process in the data storage device 3. This prevents the second backup generation process in the backup storage device 4 from affecting the execution time and performance of the first backup generation process in the data storage device 3.

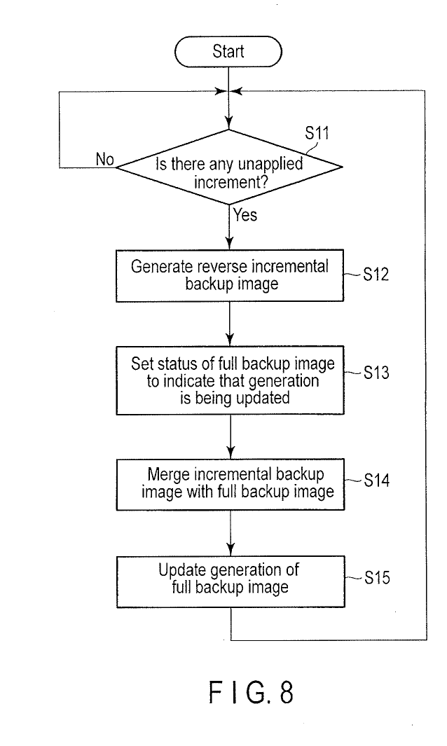

An exemplary procedure for the second backup generation process according to the embodiment will be described below with reference to a flowchart in FIG. 8. First, the reverse incremental backup generation unit 4361 of the backup processing unit 436 determines whether or not any unapplied incremental backup image is present in the incremental backup area 442 (step S11). This determination is made as follows. First, the reverse incremental backup generation unit 4361 refers to the management table 4410 in the management table area 441. The reverse incremental backup generation unit 4361 determines whether any management information for an incremental backup image is stored in the management table 4410. If no management information for any incremental backup image is stored, the reverse incremental backup generation unit 4361 determines that no unapplied incremental backup image is present in the incremental backup area 442. In contrast, if management information for an incremental backup image is stored, the reverse incremental backup generation unit 4361 determines that an unapplied incremental backup image is present in the incremental backup area 442.

If no unapplied incremental backup image is present (No in step S11), the reverse incremental backup generation unit 4361 executes step S11 again, for example, after a given time. On the other hand, if any unapplied incremental backup image is present (Yes in step S11), the reverse incremental backup generation unit 4361 proceeds to step S12.

If a single unapplied incremental backup image is present, then in step S12, the reverse incremental backup generation unit 4361 generates a reverse incremental backup image in the reverse incremental backup area 444 based on the single incremental backup image and the full backup image in the full backup area 443. When the single unapplied incremental backup image is the jth-generation incremental backup image #j-#j−1, the full backup image in the full backup area 443 is the [j−1]th-generation full backup image #j−1. In this case, the reverse incremental backup generation unit 4361 generates a reverse incremental backup image #j−1-#j based on the full backup image #j−1 and the incremental backup image #j-#j−1. As described above, j is an integer of 1 or greater. However, if j is an integer n of 2 or greater, when the reverse incremental backup image #j−1-#j (that is, #n−1-#n) is generated, at least the reverse incremental backup image #0-#1 has already been generated in the full backup area 443.

On the other hand, if two or more unapplied incremental backup images are present, then in step S12, the reverse incremental backup generation unit 4361 generates a reverse incremental backup image in the reverse incremental backup area 444 based on the one of the incremental backup images which is of the oldest generation and the full backup image in the full backup area 443. When the oldest-generation incremental backup image is the jth-generation incremental backup image #j-#j−1, the full backup image in the full backup area 443 is the [j−1]th-generation full backup image #j−1. In this case, the reverse incremental backup generation unit 4361 generates a reverse incremental backup image #j−1-#j based on the full backup image #j−1 and the incremental backup image #j-#j−1. The reverse incremental backup image #j−1-#j is used to restore a full backup image #j−1 not subjected to a merge process in step S14 described later, from a full backup image #j resulting from the merge process. The generation of the reverse incremental backup image #j−1-#j is the same as the generation ([j−1]th generation) of the full backup image #j−1 not subjected to the merge process.

Upon generating the reverse incremental backup image #j−1-#j, the reverse incremental backup generation unit 4361 generates management information used to manage the reverse incremental backup image #j−1-#j and additionally stores the generated management information in the management table 4410. The reverse incremental backup generation unit 4361 then passes control to the full backup generation unit 4362.

Then, the full backup generation unit 4362 sets the generation status of the full backup image #j−1 to indicate that the generation is being updated as follows (step S13). First, the full backup generation unit 4362 accesses the management table 4410. The full backup generation unit 4362 then sets (changes) the generation status included in the management information for the full backup image #j−1 currently stored in the full backup area 443 to indicate that the generation is being updated (more specifically, the generation is being updated from [j−1]th to jth).

According to the embodiment, when step S13 is executed, the incremental backup image #j-#j−1 is merged with the full backup image #j−1 in order to update the full backup image #j−1 to the next generation (that is, the jth generation). Thus, when this process (that is, the merge process) is started, the generation status of the full backup image #j−1 is set to indicate that the generation is being updated as described above (step S13). The generation status indicating that the generation is being updated (from [j−1]th to jth) also indicates that a merge process for merging the full backup image #j−1 with the incremental backup image #j-#j−1 is being executed.

Upon setting the generation status of the full backup image #j−1 to indicate that the generation is being updated (a merge process is being executed) (step S13), the full backup generation unit 4362 proceeds to step S14. In step S14, the full backup generation unit 4362 merges the incremental backup image #1-#j−1 (that is, the incremental backup image #j-#j−1 used to generate the reverse incremental backup image #j−1-#j in step S12) with the latest full backup image #j−1 (that is, the full backup image #j−1 used to create the reverse incremental backup image #j−1-#j in step S12) in the full backup area 443. The full backup generation unit 4362 updates the full backup image #j−1 by this merge process.

The updated full backup image #j−1 is the jth-generation full backup image #j. That is, the full backup generation unit 4362 merges the incremental backup image #j-#j−1 with the full backup image #j−1 (step S14) to update the full backup image #j−1 to generate the updated full backup image #j−1 into the jth-generation full backup image #j.

The full backup generation unit 4362 accesses the management table 4410 to clear the state in which the generation status included in the management information for the full backup image #j−1 indicates that the generation is being updated from [j−1]th to jth (step S15). In step S15, the full backup generation unit 4362 updates the generation status so that the status indicates the jth as the generation of the full backup image. Thus, the latest full backup image (first full backup image) in the full backup area 443 is changed from the [j−1]th-generation full backup image #j−1 to the jth-generation full backup image #j. Then, the full backup generation unit 4362 returns control to the reverse incremental backup generation unit 4361. Thus, the reverse incremental backup generation unit 4361 executes step S11 again.

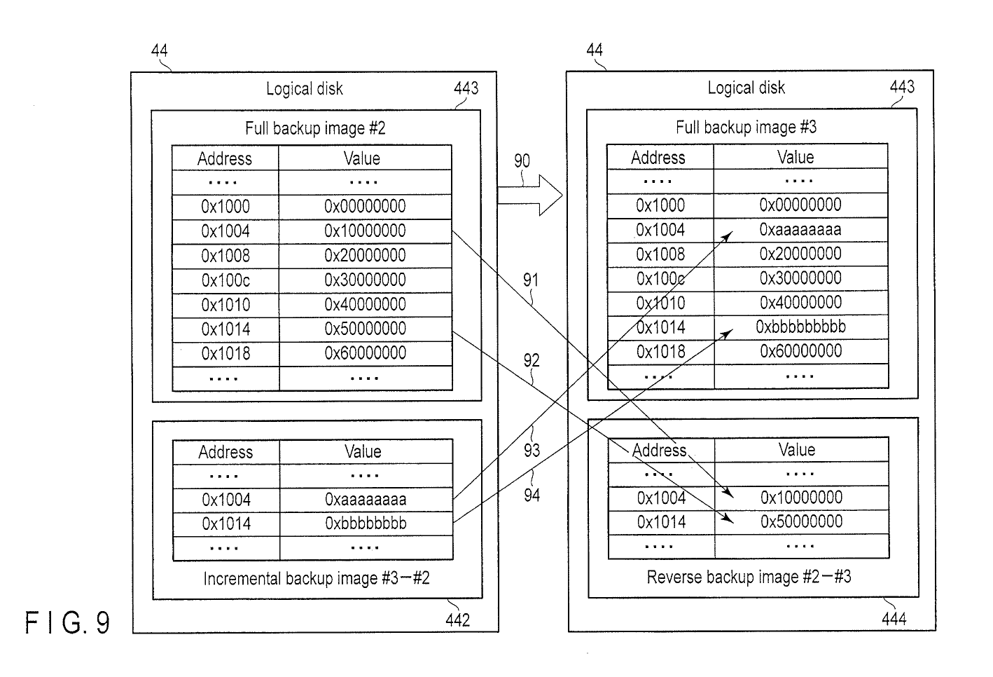

FIG. 9 is a diagram illustrating the generation of a reverse incremental backup image and a full backup image taking the generation of a second-generation incremental backup image #2-#3 and a third-generation full backup image #3 (hereinafter referred to as the target backup image generation) as an example. More specifically, FIG. 9 shows a state before the target backup image generation and a state after the target backup image generation in contrast with each other. The example in FIG. 9 assumes that, for simplification of description, all backup images each comprise an address (logical block address) and data (value) stored at the address (block designated by the logical block address).

In FIG. 9, arrow 90 shows the target backup image generation. In FIG. 9, a state in which backup images are stored in the logical disk 44 before the target backup image generation is shown on the bottom side of arrow 90. In this case, the second-generation full backup image #2 is stored in the full backup area 443 in the logical disk 44. The third-generation incremental backup image #3-#2 is stored in the incremental backup area 442 in the logical disk 44.

On the other hand, in FIG. 9, a state in which backup images are stored in the logical disk 44 after the target backup image generation is shown on the tip side of arrow 90. In this case, the third-generation full backup image #3 is stored in the full backup area 443 in the logical disk 44. The second-generation reverse incremental backup image #2-#3 is stored in the reverse incremental backup area 444 in the logical disk 44.

In the example in FIG. 9, the third-generation incremental backup image #3-#2 stored in the incremental backup area 442 before the target backup image generation includes a pair of an address 0x1004 and a value (data) 0xaaaaaaaa and a pair of an address 0x1014 and a value 0xbbbbbbbb. Here, “0x” indicates that the succeeding data is hexadecimal. Furthermore, in the example in FIG. 9, the second-generation full backup image #2 stored in the full backup area 443 before generation of the target backup image includes a pair of the address 0x1004 and a value 0x10000000 and a pair of the address 0x104 and a value 0x50000000.

The third-generation incremental backup image #3-#2 indicates an increment resulting from a data change made during a period from the second-generation backup until the third-generation backup. Thus, in the example in FIG. 9, the reverse incremental backup generation unit 4361 can recognize that the value 0x10000000 at the address 0x1004 and the value 0x50000000 at the address 0x1014 in the second-generation full backup image #2 and the third-generation incremental backup image #3-#2 have been changed to 0xaaaaaaaa and 0xbbbbbbbb, respectively, during a period from the second-generation backup until the third-generation backup. Furthermore, the reverse incremental backup generation unit 4361 can recognize that 0x1000000 and 0x5000000 are respective unchanged older versions (more specifically, values obtained at the time of the second-generation backup) of the value 0xaaaaaaaa at the address 0x1004 and the value 0xbbbbbbbb at the address 0x1014 both included in the third-generation incremental backup image #3-#2.

Thus, the reverse incremental backup generation unit 4361 executes the target backup image generation shown by arrow 90 (more specifically executes step S12 in a flowchart in FIG. 8) and thus generates a second-generation reverse incremental backup image #2-#3 as described below based on the third-generation incremental backup image #3-#2 and the second-generation full backup image #2. First, the reverse incremental backup generation unit 4361 acquires all the addresses included in the third-generation incremental backup image #3-#2. Based on the acquired addresses, the reverse incremental backup generation unit 4361 acquires all pairs of an address and a value from the second-generation full backup image #2. The reverse incremental backup generation unit 4361 generates a backup image including all the pairs of an address and a value in the reverse incremental backup area 444 as a second-generation reverse incremental backup image #2-#3.

Thus, the second-generation reverse incremental backup image #2-#3 includes all the addresses included in the third-generation incremental backup image #3-#2. The addresses included in the second-generation reverse incremental backup image #2-#3 and the third-generation incremental backup image #3-#2 are each referred to as an address Ap. In the third-generation incremental backup image #3-#2, data paired with the address Ap is referred to as first data. In the second-generation reverse incremental backup image #2-#3, data paired with the address Ap is referred to as second data. In the second-generation full backup image #2, data paired with the address Ap is referred to as third data. The third data is an unchanged version of the first data (that is, the data obtained at the time of the second-generation backup), and this third data is used as the second data.

In the example of the third-generation incremental backup image #3-#2 shown in FIG. 9, the addresses 0x1004 and 0x1014 are each the address Ap. Additionally, the first data includes the values 0xaaaaaaaa and 0xbbbbbbbb paired with the addresses 0x1004 and 0x1014 in the third-generation incremental backup image #3-#2. Furthermore, in the example of the second-generation full backup image #2 shown in FIG. 9, the third data (that is, an unchanged version of the first data) includes the values 0x10000000 and 0x50000000 paired with the addresses 0x1004 and 0x1014.

In this case, the reverse incremental backup generation unit 4361 generates a second-generation reverse incremental backup image #2-#3 including the pair of the address 0x1004 and the value 0x10000000 and the pair of the address 0x1014 and the value 0x50000000 both included in the second-generation full backup image #2, as shown by arrows 91 and 92 in FIG. 9. The second data includes the values 0x10000000 and 0x50000000 paired with the addresses 0x1004 and 0x1014 in the second-generation reverse incremental backup image #2-#3.

On the other hand, the full backup generation unit 4362 executes the target backup image generation shown by arrow 90 (more specifically, steps S13 to S15 in a flowchart in FIG. 8) and thus generates a full backup image #3 based on the incremental backup image #3-#2 and the full backup image #2. That is, the full backup generation unit 4362 merges the incremental backup image #3-#2 with the full backup image #2 and thus generates a full backup image #3. As a result of the merge, as values paired with, for example, the addresses 0x1004 and 0x1014 in the full backup image #3, the values 0xaaaaaaaa and 0xbbbbbbbb paired with the addresses 0x1004 and 0x1014 in the incremental backup image #3-#2 are used as shown by arrows 93 and 94 in FIG. 9.

If the reverse incremental backup image #2-#3 and the full backup image #3 are generated, the incremental backup image #3-#2 is unnecessary. Thus, in the embodiment, the incremental backup image #3-#2 is discarded after the generation of the reverse incremental backup image #2-#3 and the full backup image #3. If the incremental backup image #3-#2 is discarded, the management information for the incremental backup image #3-#2 is deleted from the management table 4410.

Now, restoration of data will be described which is based on the backup image in the backup storage device 4 and which is mainly executed by the data storage device 3. The host 1 is assumed to request the data storage device 3 to restore data. In general, the host 1 requests the data storage device 3 to execute the data restoration if any failure in the data storage device 3 causes the data in the backup target area 341 in the data storage device 3 to be collapsed and if the data storage device 3 then recovers from the failure. In such a case, restoration of the latest-generation data is requested. Furthermore, only in relatively rare cases, the host 1 may request the data storage device 3 to restore data even if the data storage device 3 is prevented from failing (even if the data in the backup target area 341 is prevented from being collapsed). In such a case, in general, restoration of data of a generation older than the generation of the data in the backup target area 341 is requested.

It is assumed that the host 1 requests the data storage device 3 to restore data and that restoration of the hth-generation data is requested. That is, the target generation is assumed to be the hth generation. Then, the backup processing unit 336 (more specifically, the data restoration unit 3363 in the backup processing unit 336) operating on the controller 33 of the data storage device 3 secures a data restoration area 343 for data restoration in the logical disk 34. The backup processing unit 336 then starts a data restoration process.

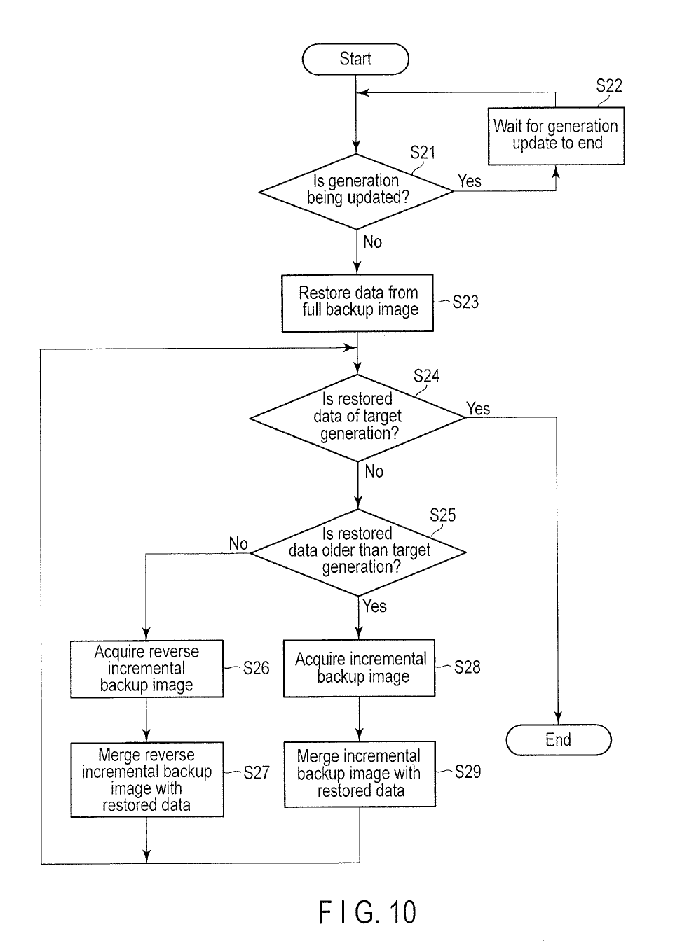

At this time, the latest full backup image stored in the full backup area 443 in the backup storage device 4 is assumed to the full backup image #n−1 or #n. Furthermore, if the latest full backup image is the full backup image #n−1, it is assumed that the full backup image #n−1 is being updated to the next nth generation. An exemplary procedure for the data restoration process will be described with reference to a flowchart in FIG. 10.

First, the data restoration unit 3363 determines whether the generation is being updated in the backup storage device 4 (step S21). More specifically, the data restoration unit 3363 determines whether the backup processing unit 436 in the backup storage device 4 is updating the generation of the latest full backup image in the backup storage device 4. That is, the data restoration unit 3363 determines whether the backup processing unit 436 is executing a merge process of merging the succeeding-generation incremental backup image with the latest full backup image. For this determination, the data restoration unit 3363 inquires of the backup processing unit 436 whether the generation is being updated.

If the generation is being updated (Yes in step S21), the data restoration unit 3363 waits for the generation update (that is, a merge process) to be finished (step S22). However, in practical use, general settings are such that a time needed to merge an incremental backup image is much longer than each of the time intervals at which the incremental backup is acquired (that is, the time intervals in the schedule for backup image generation). Thus, the need to wait for the finish of generation update in step S22 is expected to be rare. The full backup image being subjected to generation update is assumed to be, for example, the [n−1]th-generation full backup image #n−1. In this case, the generation update operation updates the [n−1]th full backup image #n−1 to the nth-generation full backup image #n (steps S14 and S15). Hence, with the generation update ended, the latest full backup image in the backup storage device 4 is the full backup image #n.

If the generation is not being updated (No in step S21), the data restoration unit 3363 proceeds to step S23. In step S23, first, the data restoration unit 3363 acquires the currently latest full backup image (that is, the full backup image stored in the full backup area 443 in the backup storage device 4) from the backup storage device 4. In this case, the latest full backup image acquired is assumed to be the full backup image #n. To allow the data restoration unit 3363 to acquire the full backup image #n, the communication unit 333 of the data storage device 3 cooperates with the communication unit 433 of the backup storage device 4 in allowing the backup storage device 4 to transfer the full backup image #n to the data storage device 3.

In step S23, based on the full backup image #n acquired, the data restoration unit 3363 further restores data in the data restoration area 343 in the logical disk 34. A technique for restoring data based on the full backup image #n is conventionally well known, and thus, a specific procedure for the technique is omitted.

If the full backup image #n (latest full backup image) is, for example, the full backup image #2 (n=2) shown in FIG. 5, then based on the full backup image #2, data (that is, the second-generation data) is restored. In contrast, if the full backup image #n is, for example, the full backup image #3 (n=3) shown in FIG. 9, then based on the full backup image #3, data (that is, the third-generation data) is restored.

Then, the data restoration unit 3363 determines whether the generation (that is, the nth generation) of the restored data (more specifically, the latest restored data) is the generation of data to be restored as requested by the host 1 (that is, the target generation) (step S24). If the generation (nth generation) of the restored data is the target generation (that is, the hth generation) (Yes in step S24), the data restoration unit 3363 ends the restoration process.

The latest incremental backup image stored in the incremental backup area 442 of the backup storage device 4 is assumed to be the mth-generation (m is an integer of 2 or greater) incremental backup image #m-#m−1. In this case, the target generation is generally the mth generation (that is, h=m). Furthermore, for the above-described reason, the latest full backup image stored in the full backup area 443 in the backup storage device 4 is likely to be the mth-generation (that is, the target-generation) full backup image #m.

Hence, the generation (nth generation) of the first data to be restored (that is, the data to be restored in step S23) is likely to be the mth generation (that is, n=m). This also applies to a case where the latest full backup image stored in the full backup area 443 is the [m−1]th-generation full backup image #m−1 and where the full backup image #m−1 is being subjected to generation update. This is because the first data restoration (step S23) is not executed until the generation update is finished (steps S22 and S21) as described above. That is, the embodiment is likely to allow the latest-generation data (that is, the latest backup image) to be restored by the first restoration operation, thus enabling a reduction in time needed for a process of restoring the latest backup image.

In contrast, the conventional technique needs to use incremental backup images of all generations in order to restore the latest-generation data. Thus, the conventional technique takes much time for data restoration. According to the conventional technique, in order to reduce the time needed for data restoration, the backup storage device 4 needs to acquire full backup images instead of incremental backup images from the data storage device 3, for example, at predetermined generation intervals. That is, the backup storage device 4 needs to store full backup images at predetermined generation intervals. To achieve this, the full backup images need to be transferred from the data storage device to the backup storage device. This may increase the amount of data transferred between the data storage device and the backup storage device, reducing the operating rate of the backup storage system.

However, in the embodiment, the backup storage device 4 has only to store a full backup image of the latest-generation (that is, one generation). Thus, the embodiment can save the capacity of the full backup area 443 and prevent a possible decrease in the operating rate of the backup storage system.

If the target generation is the mth (h=m) generation, the data restoration unit 3363 may restore data in the backup target area 341. That is, the backup target area 341 may be used as a data restoration area 343 (fourth storage area).

Now, a case will be described where the generation (nth generation) of the restored data is not the target generation (hth generation) (n≠h) (No in step S24). In this case, the data restoration unit 3363 determines whether the generation (nth generation) of the restored data is older than the target generation (hth generation) (n<h) (step S25). If the generation (nth generation) of the restored data is not older than the target generation (hth generation) (No in step S25), that is, if the generation of the restored data is newer than the target generation (n>h), the data restoration unit 3363 acquires a reverse incremental backup image (the reverse incremental backup image #n−1-#n) of the generation ([n−1]th generation) preceding the restored data (nth generation) from the backup storage device 4 (step S26). To allow the data restoration unit 3363 to acquire the reverse incremental backup image #n−1-#n, the communication unit 333 of the data storage device 3 cooperates with the communication unit 433 of the backup storage device 4 in allowing the backup storage device 4 to transfer the reverse incremental backup image #n−1-#n to the data storage device 3.

The data restoration unit 3363 merges the reverse incremental backup image #n−1-#n acquired in step S26 with the restored data (more specifically, the restored nth-generation data) (step S27). Thus, the data restoration unit 3363 restores the data of the generation ([n−1]th generation) preceding the nth generation. Then, the data restoration unit 3363 returns to step S24. Thus, the data restoration unit 3363 repeats steps S26 and S27 until the generation of the latest restored data matches the target generation (hth generation) (Yes in step S24).

It is assumed that n is an integer of 2 or greater and that h is an integer satisfying 0≦h<n≦m. In this case, in the first steps S26 and S27, the data restoration unit 3363 merges the reverse incremental backup image #n-#n−1 with the nth-generation data restored based on the full backup image #n. Thus, the [n−1]th-generation data is restored.

If h=n−1, the restoration process ends because the restored [n−1]th-generation data is of the target generation (Yes in step S24). In contrast, if h is not n−1, the restored [n−1]th-generation data is not of the target generation (No in step S24), the second steps S26 and S27 are executed. Thus, the reverse incremental backup image #n−1-#n−2 is merged with the restored [n−1]th-generation data and thus the [n−2]th-generation data is restored.

If h=n−2, the restoration process ends because the restored [n−2]th-generation data is of the target generation (Yes in step S24). In contrast, if h is not n−2, the restored [n−2]th-generation data is not of the target generation (No in step S24), and the third steps S26 and S27 are executed. Thus, steps S26 and S27 are repeated until the generation of the latest restored data matches the target generation (hth generation) (Yes in step S24).

Now, a case will be described where the generation (nth generation) of the latest restored data is older than the target generation (hth generation) (n<h) (Yes in step S25). Such a case results from a situation where the generation update (merge process) in the backup storage device 4 is delayed. The situation where the generation update is delayed refers to a situation where the generation update fails to catch up with the generation and transfer of an incremental backup image executed in the data storage device 3 at every backup timing. However, such a situation is unlikely to occur for the above-describe reason.

The data restoration unit 3363 acquires, from the backup storage device 4, an incremental backup image (that is, incremental backup image #n+1-#n) of the generation ([n+1]th generation) succeeding the restored data (nth generation) (step S28). To allow the data restoration unit 3363 to acquire the incremental backup image #n+1-#n, the communication unit 333 of the data storage device 3 cooperates with the communication unit 433 of the backup storage device 4 in allowing the backup storage device 4 to transfer the incremental backup image #n+1-#n to the data storage device 3.

The data restoration unit 3363 merges the incremental backup image #n+1-#n acquired in step S28 with the restored data (more specifically, the restored nth-generation data) (step S29). Thus, the data restoration unit 3363 restores the data of the generation ([n+1]th generation) succeeding the nth generation. Then, the data restoration unit 3363 returns to step S24. Thus, the data restoration unit 3363 repeats steps S28 and S29 until the generation of the latest restored data matches the target generation (hth generation) (Yes in step S24).

It is assumed that h is an integer satisfying 0≦n<h≦m. In this case, in the first steps S28 and S29, the data restoration unit 3363 merges the incremental backup image #n+1-#n with the nth-generation data restored based on the full backup image #n. Thus, the [n+1]th-generation data is restored.

If h=n+1, the restoration process ends because the restored [n+1]th-generation data is of the target generation (Yes in step S24). In contrast, if h is not n+1, the restored [n+1]th-generation data is not of the target generation (No in step S24), and the second steps S28 and S29 are executed. Thus, the incremental backup image #n+2-#n+1 is merged with the restored [n+1]th-generation data and thus the [n+2]th-generation data is restored.

If h=n+2, the restoration process ends because the restored [n+2]th-generation data is of the target generation (Yes in step S24). In contrast, if h is not n+2, the restored [n+2]th-generation data is not of the target generation (No in step S24), and the third steps S28 and S29 are executed. Thus, steps S28 and S29 are repeated until the generation of the latest restored data matches the target generation (hth generation) (Yes in step S24).

The number of reverse incremental backup images stored in the reverse incremental backup area 444 of the backup storage device 4 increases with progression of the backup schedule. Thus, the reverse incremental backup area 444 may be full of reverse incremental backup images. In such a case, to secure a free space in the reverse incremental backup area 444, the reverse incremental backup generation unit 4361 discards (deletes), for example, the oldest reverse incremental backup image in the reverse incremental backup area 444.

In the embodiment, even if incremental backup images are needed to restore data (No in step S25), the reverse incremental backup images are sequentially used starting with the latest generation. Thus, data restoration is not affected even when the oldest reverse incremental backup image in the reverse incremental backup area 444 is discarded. That is, even when the oldest reverse incremental backup image is discarded, all full backup images of subsequent generations can be restored. Furthermore, since the oldest reverse incremental backup image may be exclusively discarded, the operation of sequentially discarding backup images in order of increasing generation is facilitated. If the reverse incremental backup area 444 is full of reverse incremental backup images, a given number of the reverse incremental backup images in the reverse incremental backup area 444 may be sequentially discarded in order of increasing generation.

In contrast, according to the conventional technique, when the oldest incremental backup image corresponding to the oldest reverse incremental backup image is discarded, full backup images of the subsequent generations are precluded from being restored. Thus, the conventional technique needs to merge the oldest incremental backup image with a full backup image to update the full backup image to the succeeding-generation backup image and then discard the oldest incremental backup image.

Now, an operation will be described which is performed to resume the second backup generation process suspended due to a failure in the backup storage device 4. First, it is assumed that a failure occurs in the backup storage device 4 (for example, power shutdown in the backup storage device 4) during the generation update in the backup storage device 4, causing the second backup generation process to be unexpectedly suspended. It is further assumed that the backup storage device 4 is subsequently restored from the failure.

Then, the backup processing unit 436 of the backup storage device 4 resumes the second backup generation process. A position where the second backup generation process is resumed varies depending on whether or not the generation status of the full backup image in the full backup area 443 indicates that the generation is being updated.

First, the resumption of the second backup generation process which is executed if the status of the full backup image in the full backup area 443 indicates that the generation is being updated will be described. It is assumed that the full backup image in the full backup area 443 is the full backup image #j−1. In this case, the full backup generation unit 4362 executes a process of merging the incremental backup image #j-#j−1 with the full backup image #j−1 (step S14) from the start regardless of the progress of generation update before suspension. A part of the full backup image #j−1 may have been merged with the incremental backup image #j-#j−1 during step S14 of the second backup generation process before suspension. However, the merged part of the full backup image #j−1 may be merged again (overwritten) with the incremental backup image #j-#j−1 without any problem.

Now, the resumption of the second backup generation process will be described which is executed when the generation status of the full backup image in the full backup area 443 does not indicate that the generation is being updated. In this case, the reverse incremental backup generation unit 4361 executes a process of generating a reverse incremental backup based on the full backup image in the full backup area 443 and the succeeding-generation incremental backup image in the incremental backup area 442 (step S12) from the start. The succeeding-generation incremental backup image refers to an incremental backup image of the generation succeeding the generation of the full backup image in the full backup area 443. The generation of the full backup image is indicated by the generation status of the full backup image. For example, if the full backup image is of the [j−1]th generation, the succeeding-generation incremental backup image is the jth-generation incremental backup image #j-#j−1. Furthermore, if the full backup image is of the jth generation, the succeeding-generation incremental backup image is the [j+1]th-generation incremental backup image #j+1-#j.

It is assumed that the second backup generation process is suspended before the jth-generation incremental backup image #j-#j−1 is merged with the [j−1]th full backup image #j−1 and that the merge is followed by the resumption of the second backup generation process. In this case, the full backup generation unit 4362 executes a process of generating a [j−1]th-generation reverse incremental backup #j−1-#j based on the [j−1]th-generation full backup image #j−1 and the jth-generation incremental backup image #j-#j−1 (step S12) from the start.

Then, it is assumed the jth-generation incremental backup image #j-#j−1 is merged with the [j−1]th-generation full backup image #j−1 to generate a jth-generation full backup image #j and that the second backup generation process is then suspended and subsequently resumed. In this case, the full backup generation unit 4362 executes a process of generating a jth-generation reverse incremental backup image #j-#j+1 based on the jth-generation full backup image #j and the [j+1]th-generation incremental backup image #j+1-#j (step S12) from the start.

### MODIFICATION

Now, a modification of the embodiment will be described. The basic configuration of the modification is similar to the configuration of the embodiment. The modification differs from the embodiment in the data structure of, for example, the ith-generation incremental backup image generated by the incremental backup generation unit 3362b in the data storage device 3. That is, for example, the ith-generation incremental backup image applied in the modification includes not only an increment from the [i−1]th-generation backup until the ith-generation backup (that is, new data) but also the [i−1]th-generation data corresponding to the increment (that is, old data).

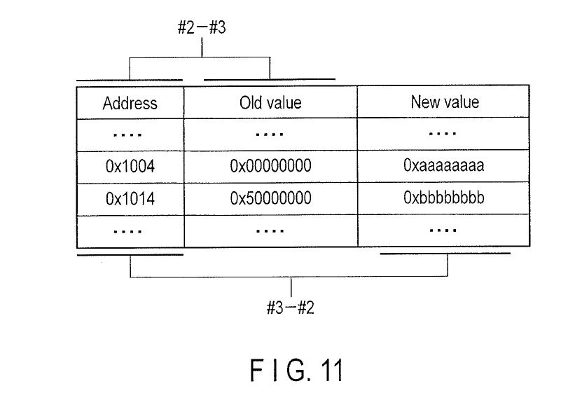

FIG. 11 shows an example (i=3) of a third-generation incremental backup image applied in the modification. The third-generation incremental backup image includes a group of an address 0x1004, an old value (old data) 0x10000000, and a new value (new data) 0xaaaaaaaa and a group of an address 0x1014, an old value (old data) 0x50000000, and a new value (new data) 0xbbbbbbbb.

In the third-generation incremental backup image shown in FIG. 11, a backup image comprising a set of pairs of an address and a new value corresponds to the third-generation incremental backup image #3-#2 shown in FIG. 9. Thus, the third-generation incremental backup image shown in FIG. 11 is the third-generation incremental backup image #3-#2.

Furthermore, in the third-generation incremental backup image shown in FIG. 11, a backup image comprising a set of pairs of an address and an old value corresponds to the second-generation reverse incremental backup image #2-#3 shown in FIG. 9. Thus, the reverse incremental backup generation unit 4361 of the backup storage device 4 can acquire the second-generation reverse incremental backup image #2-#3 from the third-generation incremental backup image shown in FIG. 11 without the need for a special operation. Hence, the modification can omit the generation of a reverse incremental backup image (step S12) from the flowchart in FIG. 8.

The embodiment and modification assume that a single full backup image is stored in the backup storage device 4. However, to ensure a full backup image in a complete state, at least two full backup images, for example, two full backup storages, may be stored in the backup storage device 4. In this case, the full backup generation unit 4362 may avoid simultaneously merging an incremental backup image with the two full backup images in step S14 in the flowchart in FIG. 8. That is, the full backup generation unit 4362 may merge the incremental backup image with one of the two full backup images, and after completion of this merge process, merge the incremental backup image with the other of the two full backup images. This ensures the presence, at any point of time, of a full backup image that is in a complete state and is not currently being subjected to a merge process.

At least one embodiment described above can provide a backup storage system, a backup storage apparatus, and a data backup method which enable a reduction in time needed to restore the latest generation data.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A backup storage system comprising:
a data storage apparatus configured to store data accessed by a host computer; and
a backup storage apparatus configured to store a backup image of the data stored in the data storage apparatus,
wherein the data storage apparatus comprises:
a backup generation unit configured to generate a first-generation full backup image during a first backup as the backup image and to generate an incremental backup image during each backup succeeding the first backup as the backup image, the incremental backup image representing an increment resulting from a data change made since a preceding-generation backup; and
a backup image transfer unit configured to transfer the first-generation full backup image to a first storage area in the backup storage apparatus when the first-generation full backup image is generated and to transfer the incremental backup image to a second storage area in the backup storage apparatus when the incremental backup image is generated,
wherein the backup storage apparatus comprises:
a full backup generation unit configured to repeat a merge process for updating a first full backup image to a succeeding-generation full backup image by merging an incremental backup image of a generation succeeding the first full backup image with the first full backup image, with the first full backup image stored in the first storage area and with at least the succeeding-generation incremental backup image stored in the second storage area; and
a reverse incremental backup acquisition unit configured to repeat, in order of generation, an operation for acquiring and storing a reverse incremental backup image of a generation identical to a generation of the full backup image not subjected to the merge process, in a third area in the backup storage apparatus based on the incremental backup image transferred to the second storage area, the reverse incremental backup image representing a part of the full backup image not subjected to the merge process and being used to restore the full backup image not subjected to the merge process from the full backup image subjected to the merge process, the part of the full backup image not subjected to the merge process corresponding to the succeeding-generation incremental backup image.

2. The backup storage system of claim 1, wherein the data storage apparatus further comprises a data restoration unit configured to:
acquire the first full backup image stored in the first storage area from the backup storage apparatus when first-generation data is to be restored;
restore first data in a fourth storage area in the data storage apparatus based on the acquired first full backup image; and
end data restoration when a generation of the first data matches the first generation.

3. The backup storage system of claim 2, wherein the data restoration unit is configured to repeat a restoration operation for newly restoring, as the first data, data of a generation succeeding the first data in the fourth storage area until the generation of the first data matches the first generation when the generation of the first data is older than the first generation, the restoration operation comprising acquiring an incremental backup image of a generation succeeding the first data stored in the second storage area from the backup storage apparatus and merging the acquired succeeding-generation incremental backup image with the first data.

4. The backup storage system of claim 2, wherein the data restoration unit is configured to repeat a restoration operation for newly restoring, as the first data, data of a generation preceding the first data in the fourth storage area until the generation of the first data matches the first generation when the generation of the first data is newer than the first generation, the restoration operation comprising acquiring a reverse incremental backup image of a generation preceding the first data stored in the third storage area from the backup storage apparatus and merging the acquired preceding-generation reverse incremental backup image with the first data.

5. The backup storage system of claim 1, wherein the reverse incremental backup acquisition unit is configured to acquire the reverse incremental backup image by generating the reverse incremental backup image based on the succeeding-generation incremental backup image and the full backup image not subjected to the merge process.

6. The backup storage system of claim 1, wherein:
the incremental backup image comprises new data resulting from a data change made since the preceding-generation backup and old data not subjected to the data change; and
the reverse incremental backup acquisition unit is configured to acquire the reverse incremental backup image including the old data from the incremental backup image transferred to the second storage area.

7. A backup storage apparatus configured to store a backup image of data stored in a data storage apparatus and accessed by a host computer, the backup storage apparatus comprising:
a first storage area configured to store a first-generation full backup image generated during a first backup in the data storage apparatus as the backup image and transferred from the data storage apparatus to the backup storage apparatus;
a second storage area configured to store an incremental backup image representing an increment resulting from a data change made since a preceding-generation backup, the incremental backup image being generated as the backup image during each backup succeeding a first backup in the data storage apparatus and transferred from the data storage apparatus to the backup storage apparatus;
a full backup generation unit configured to repeat a merge process for updating a first full backup image to a succeeding-generation full backup image by merging an incremental backup image of a generation succeeding the first full backup image with the first full backup image, with the first full backup image stored in the first storage area and with at least the succeeding-generation incremental backup image stored in the second storage area; and
a reverse incremental backup acquisition unit configured to repeat, in order of generation, an operation for acquiring and storing a reverse incremental backup image of a generation identical to a generation of the full backup image not subjected to the merge process, in a third area in the backup storage apparatus based on the incremental backup image transferred to the second storage area, the reverse incremental backup image representing a part of the full backup image not subjected to the merge process and being used to restore the full backup image not subjected to the merge process from the full backup image subjected to the merge process, the part of the full backup image not subjected to the merge process corresponding to the succeeding-generation incremental backup image.

8. The backup storage apparatus of claim 7, wherein the reverse incremental backup acquisition unit is configured to acquire the reverse incremental backup image by generating the reverse incremental backup image based on the succeeding-generation incremental backup image and the full backup image not subjected to the merge process.

9. The backup storage apparatus of claim 7, wherein:
the incremental backup image comprises new data resulting from a data change made since the preceding-generation backup and old data not subjected to the data change; and
the reverse incremental backup acquisition unit is configured to acquire the reverse incremental backup image including the old data from the incremental backup image transferred to the second storage area.

10. A method, implemented in a backup storage system, for backing up data, the backup storage system comprising a data storage apparatus configured to store data accessed by a host computer and a backup storage apparatus configured to store a backup image of the data stored in the data storage apparatus, the method comprising:
generating a first-generation full backup image during a first backup in the data storage apparatus as the backup image;
generating an incremental backup image during each backup succeeding the first backup in the data storage apparatus as the backup image, the incremental backup image representing an increment resulting from a data change made since a preceding-generation backup;
transferring the first-generation full backup image from the data storage apparatus to a first storage area in the backup storage apparatus when the first-generation full backup image is generated;
transferring the incremental backup image from the data storage apparatus to a second storage area in the backup storage apparatus when the incremental backup image is generated,
repeating, in the backup storage apparatus, a merge process for updating a first full backup image to a succeeding-generation full backup image by merging an incremental backup image of a generation succeeding the first full backup image with the first full backup image, with the first full backup image stored in the first storage area and with at least the succeeding-generation incremental backup image stored in the second storage area; and
repeating, in order of generation, an operation for acquiring and storing a reverse incremental backup image of a generation identical to a generation of the full backup image not subjected to the merge process, in a third area in the backup storage apparatus based on the incremental backup image transferred to the second storage area, the reverse incremental backup image representing a part of the full backup image not subjected to the merge process and being used to restore the full backup image not subjected to the merge process from the full backup image subjected to the merge process, the part of the full backup image not subjected to the merge process corresponding to the succeeding-generation incremental backup image.

11. The method of claim 10, further comprising:
acquiring the first full backup image stored in the first storage area from the backup storage apparatus when first-generation data is to be restored;
restoring first data in a fourth storage area in the data storage apparatus based on the acquired first full backup image; and
ending data restoration when a generation of the first data matches the first generation.

12. The method of claim 11, further comprising repeating a restoration operation for newly restoring, as the first data, data of a generation succeeding the first data in the fourth storage area until the generation of the first data matches the first generation when the generation of the first data is older than the first generation, the restoration operation comprising acquiring an incremental backup image of a generation succeeding the first data stored in the second storage area from the backup storage apparatus and merging the acquired succeeding-generation incremental backup image with the first data.

13. The method of claim 11, further comprising repeating a restoration operation for newly restoring, as the first data, data of a generation preceding the first data in the fourth storage area until the generation of the first data matches the first generation when the generation of the first data is newer than the first generation, the restoration operation comprising acquiring a reverse incremental backup image of a generation preceding the first data stored in the third storage area from the backup storage apparatus and merging the acquired preceding-generation reverse incremental backup image with the first data.

14. The method of claim 10, wherein the operation for acquiring and storing the reverse incremental backup image comprises generating the reverse incremental backup image based on the succeeding-generation incremental backup image and the full backup image not subjected to the merge process.

15. The method of claim 10, wherein:
the incremental backup image comprises new data resulting from a data change made since the preceding-generation backup and old data not subjected to the data change; and
the operation for acquiring and storing the reverse incremental backup image comprises acquiring the reverse incremental backup image including the old data from the incremental backup image transferred to the second storage area.
